(19) United States
(12) Patent Application Publication
(10) Pub. No.: US 2018/0324478 A1
(43) Pub. Date: Nov. 8, 2018

(54) SYSTEM AND METHOD FOR MANAGING CONTENT PRESENTATION ON CLIENT DEVICES

(71) Applicant: Cognant LLC, Mountain View, CA (US)

(72) Inventor: Jared Maruskin, San Jose, CA (US)

(21) Appl. No.: 15/966,416

(22) Filed: Apr. 30, 2018

Related U.S. Application Data
(60) Provisional application No. 62/500,119, filed on May 2, 2017.

(51) Int. Cl. H04N 21/2665; G06Q 30/08; H04N 21/442; G06F 17/30

(52) U.S. Cl. CPC H04N 21/2665; G06Q 30/08; G06F 17/30058; G06F 17/3005; H04N 21/4424

(57) ABSTRACT

Implementations of the present disclosure are directed to a method, a system, and an article for managing the presentation of content on client devices. An example computer-implemented method can include implementing a plurality of content modules for a plurality of content channels. Each content module can be configured to identify target client devices for receiving content, and each content channel can be configured to present content on the target client devices. The method can further include: receiving an offer from each of a plurality of content providers to provide content for one of the content modules on one or more content channels; selecting one of the offers from one of the content providers; choosing an item of content from the content provider associated with the selected offer; and presenting the chosen item of content on at least one of the target client devices using the one or more content channels.

### CROSS-REFERENCE TO RELATED APPLICATIONS

This application claims the benefit of U.S. Provisional Patent Application No. 62/500,119, filed May 2, 2017, the entire contents of which are incorporated by reference herein.

### BACKGROUND

The present disclosure relates generally to digital content and, in some examples, to systems and methods for managing the presentation of digital content on client devices.

Client devices are generally capable of presenting a wide variety of digital content, including images, video, audio, or combinations thereof. Such content can be stored locally on the client devices and/or can be sent to the client devices from server computers over a network (e.g., the Internet). To watch an online movie, for example, a user of a client device can download a copy of the movie and/or can stream the movie from a website, software application, or other channel.

In many situations, the providers of content can have access to a limited number of channels for distributing content to end users. A typical content provider, for example, may utilize a single channel (e.g., a website or software application) to distribute video or audio content to users. This can make it difficult for the content provider to reach a desired audience, particularly when most users of interest receive content from other channels.

### SUMMARY

In general, the subject matter described herein relates to computer-implemented systems and methods for managing the presentation of content (e.g., video, audio, images, and/or text) on client devices. One or more content modules can be implemented on each of a plurality of content channels (e.g., websites and/or software applications). The content modules are generally configured to target specific client devices, for example, according to device type, device location, operating system, and platform (e.g., ANDROID), to ensure that the content presented on the client devices is compatible with the client devices and/or end users. In a typical example, content providers can submit offers to a content manager that, in turn, can select one or more of the offers based on various criteria, including, for example, device compatibility, device type, device location, operating system, platform, etc. After selecting an offer, the content manager can provide an item of content associated with the offer to the content module for presentation on one or more client devices. When a new offer is selected and replaces an old offer, new content associated with the new offer can be presented on the client devices, using the content module and the associated content channel.

Advantageously, the systems and methods described herein can enable content providers to achieve a broad distribution of content to a desired set of client devices. The content providers can utilize content modules that have been implemented by the content manager, preferably across a large number and variety of channels. The ability of content providers to reach the users of these channels is significantly improved and, compared to previous approaches, such users can have access to a wider variety of compatible content, from a larger number of content providers.

Additionally or alternatively, the systems and methods described herein can achieve significant improvements in the ability of a computer system to distribute content to end users. In general, by providing content providers with greater access to a larger number of channels, the content providers and related computer systems are able to distribute content more efficiently to a larger number and variety of end users. In some instances, for example, the systems and methods described herein can enable content providers to increase the number of end users by a factor of 2, 5, 10, or more. Likewise, the end users can be given access to content from a pool of content providers that is larger by a factor of 2, 5, 10, or more. Additionally or alternatively, by utilizing the content modules, content providers can reach a target group of client devices that are compatible with the content.

In one aspect, the subject matter described in this specification relates to a computer-implemented method. The method includes: implementing a plurality of content modules for a plurality of content channels, wherein each content module is configured to identify target client devices for receiving content, and wherein each content channel is configured to present content on the target client devices; receiving an offer from each of a plurality of content providers to provide content for one of the content modules on one or more content channels; selecting one of the offers from one of the content providers; choosing an item of content from the content provider associated with the selected offer; and presenting the chosen item of content on at least one of the target client devices using the one or more content channels.

In certain examples, each content module can be configured to identify the target client devices based on one or more client device features. The one or more client device features can include, for example, device type, device location, operating system, platform, and any combination thereof. The one or more content channels can include a website and/or a software application. The chosen item of content can include an image and/or a video. The chosen item of content can include a click destination universal resource locator.

In some implementations, presenting the chosen item of content can include providing the chosen item of content from a content server to the one or more content channels. Presenting the chosen item of content can include: submitting a second offer to provide the chosen item of content on the one or more content channels; and receiving an acceptance of the second offer. The method can also include: receiving a third offer from each of the plurality of content providers to provide content for the one of the content modules on the one or more content channels; selecting one of the third offers from a different one of the content providers; choosing a new item of content from the content provider associated with the selected third offer; and presenting the new item of content on at least one of the target client devices using the one or more content channels. The content can include a bundling of bulk content inventory.

In another aspect, the subject matter described in this specification relates to a system. The system includes one or more computer processors programmed to perform operations including: implementing a plurality of content modules for a plurality of content channels, wherein each content module is configured to identify target client devices for receiving content, and wherein each content channel is configured to present content on the target client devices; receiving an offer from each of a plurality of content providers to provide content for one of the content modules on one or more content channels; selecting one of the offers from one of the content providers; choosing an item of content from the content provider associated with the selected offer; and presenting the chosen item of content on at least one of the target client devices using the one or more content channels.

In certain examples, each content module can be configured to identify the target client devices based on one or more client device features. The one or more client device features can include, for example, device type, device location, operating system, platform, and any combination thereof. The one or more content channels can include a website and/or a software application. The chosen item of content can include an image and/or a video. The chosen item of content can include a click destination universal resource locator.

In some implementations, presenting the chosen item of content can include providing the chosen item of content from a content server to the one or more content channels. Presenting the chosen item of content can include: submitting a second offer to provide the chosen item of content on the one or more content channels; and receiving an acceptance of the second offer. The operations can also include: receiving a third offer from each of the plurality of content providers to provide content for the one of the content modules on the one or more content channels; selecting one of the third offers from a different one of the content providers; choosing a new item of content from the content provider associated with the selected third offer; and presenting the new item of content on at least one of the target client devices using the one or more content channels. The content can include a bundling of bulk content inventory.

In another aspect, the subject matter described in this specification relates to an article. The article includes a non-transitory computer-readable medium having instructions stored thereon that, when executed by one or more computer processors, cause the computer processors to perform operations including: implementing a plurality of content modules for a plurality of content channels, wherein each content module is configured to identify target client devices for receiving content, and wherein each content channel is configured to present content on the target client devices; receiving an offer from each of a plurality of content providers to provide content for one of the content modules on one or more content channels; selecting one of the offers from one of the content providers; choosing an item of content from the content provider associated with the selected offer; and presenting the chosen item of content on at least one of the target client devices using the one or more content channels.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims

### DESCRIPTION OF THE DRAWINGS

FIG. 1 is a schematic diagram of an example system for managing the presentation of digital content on client devices.

FIG. 2 is an example data flow diagram for a method of managing the presentation of digital content on client devices.

FIG. 3 is a flowchart of an example method of managing the presentation of digital content on client devices.

### DETAILED DESCRIPTION

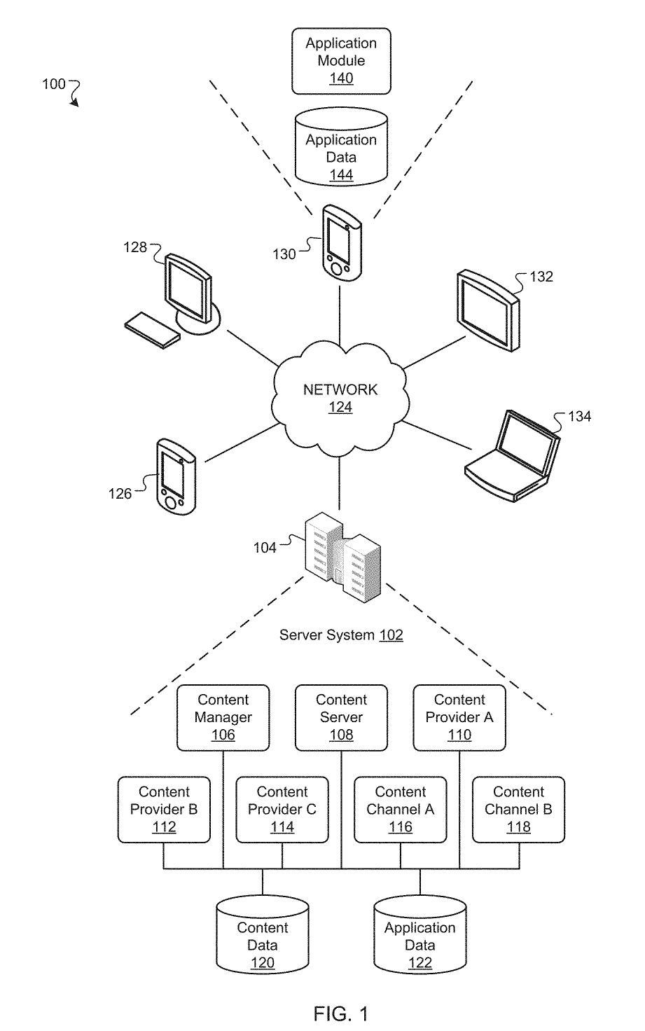

FIG. 1 illustrates an example system 100 for providing digital content to client devices through a plurality of content channels. A server system 102 provides functionality for distributing content from multiple content providers through the content channels. The server system 102 includes software components and databases that can be deployed at one or more data centers 104 in one or more geographic locations, for example. The server system 102 software components can include a content manager 106, a content server 108, one or more content providers (e.g., content provider A 110, content provider B 112, content provider C 114, and/or any other number of content providers), and one or more content channels (e.g., content channel A 116, content channel B 118, and/or any other number of content channels). The server system 102 can include subcomponents that can execute on the same or on different individual data processing apparatus. It is understood, for example, that each software component can execute on a different server computer, or that more than one software component can execute on the same server computer, in any combination. The server system 102 databases can include a content data 120 database and an application data 122 database. The databases can reside in one or more physical storage systems and can exchange data and information with any of the software components. In certain instances, the server system 102 includes or utilizes a content delivery network (CDN). The software components and data will be further described below.

An application, such as, for example, a web-based or other software application can be provided as an end-user application to allow users to interact with the server system 102. The software application or components thereof can be accessed through a network 124 (e.g., the Internet) by users of client devices, such as a smart phone 126, a personal computer 128, a smart phone 130, a tablet computer 132, and a laptop computer 134. Other client devices are possible. The client devices can connect to the network 124 using, for example, a wireless connection, a Wi-Fi connection, and/or a cellular connection.

Each client device in the system 100 can utilize or include software components and databases for providing the software application and/or presenting content. The software components on the client devices can include an application module 140, which can implement the software application on each client device. The databases on the client devices can include an application data 144 database, which can store content or data (e.g., for the software application) and exchange the content or data with the application module 140. The data stored on the application data 144 database can include, for example, user data, image data, video data, and any other data or content used or generated by the application module 140. While the application module 140 and the application data 144 database are depicted as being associated with the smart phone 130, it is understood that other client devices (e.g., the smart phone 126, the personal computer 128, the tablet computer 132, and/or the laptop computer 134) can include the application module 140, the application data 144 database, and any portions thereof.

In some examples, the server system 102 can include software components that support the software application by, for example, performing calculations, implementing software updates, exchanging information, content, or data with the application module 140, and/or monitoring an overall status of the software application. The application data 122 database can store and provide data for the software application. The data can include, for example, user data, image data, video data, animation data, and/or any other content or data that can be used by the server system 102 and/or client devices (e.g., to run the software application).

The software application implemented on the client devices 126, 128, 130, 132, and 134 can relate to and/or provide a wide variety of functions and information, including, for example, entertainment (e.g., a game, music, images, videos, etc.), business (e.g., word processing, accounting, spreadsheets, etc.), news, weather, finance, sports, web browsing, etc. In certain instances, the software application provides a multi-player online game.

Still referring to FIG. 1, the content manager 106 can include software components that can manage the presentation of content on the client devices 126, 128, 130, 132, and 134. In certain instances, for example, the content manager 106 can utilize the one or more content channels (e.g., content channel A 116, content channel B 118, and/or any other number of content channels) to present the content. Each content channel can be, include, or utilize a website or software application to present content on the client devices. A content channel can include or be operated by, for example, a content provider, a content distributor, and/or an advertising network. In one example, a content channel can be a software application that presents video or image content on a client device.

In various examples, the content manager 106 can establish and manage one or more content modules on each content channel. The content modules can be, include, or utilize software and/or data processing components configured to identify specific groups of client devices that will receive various forms of content. For example, a first content module on content channel A 116 can identify or target client devices that meet certain criteria (e.g., a device type, an operating system, a type of network connection, etc.). Likewise, a second content module on content channel A 116 can identify or target client devices that meet certain other criteria (e.g., a geographical location, a connection history, etc.). Similar content modules can be established on content channel B 118 and other channels.

In general, the one or more content providers (e.g., content provider A 110, content provider B 112, and content provider C 114) can be, include, or utilize software components that develop, identify, and/or provide content for possible presentation on client devices. The content providers can be or include, for example, software components and/or databases for content repositories, content service providers, content developers, promoters, and/or advertisers. Content provided by the content providers can be stored in the content data 120 database. The content server 108 can retrieve the content from the content data 120 database and send it to the client devices, via the content channels, as described herein.

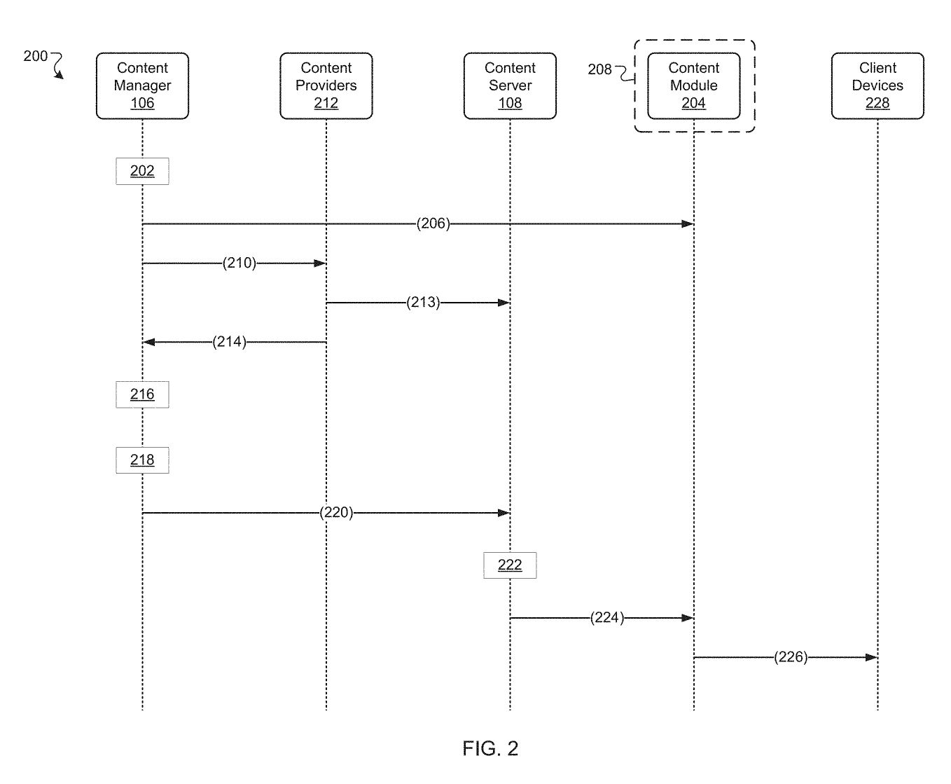

FIG. 2 is a data flow diagram of an example method 200 for distributing content to client devices using a plurality of content channels. The method 200 can begin when the content manager 106 develops (step 202) a content module 204 for presenting content (e.g., video, audio, images, or any combination thereof). The content module 204 can include a set of criteria (e.g., device type, operating system, connection type, etc.) for client devices targeted by the content module 204. The content manager 106 can then implement (step 206) the content module 204 on a content channel 208 (e.g., content channel A 116), which can be or include a website, software application, or online publication configured to present content on the targeted client devices. In some examples, implementing the content module 204 can involve acquiring a content inventory on the content channel 208. The content inventory can be or include, for example, space that is allocated for the presentation of content on a website, software application, or other publication for the content channel 208. Once the content module 204 has been implemented (e.g., using the content channel integration described herein), the content manager 106 can inform (step 210) a group of content providers 212 (e.g., including content provider A 110, content provider B 112, and content provider C 114) about the existence of the content module 204. In response, the content providers 212 can provide (step 213) the content server 108 with access to content developed or otherwise made available by the content providers 212. For example, the content providers 212 can store the content in the content data 120 database and permit the content server 108 to access the content in the content data 120 database.

Next, the content providers can submit (step 214) offers to the content manager 106 for an opportunity to present content in the content module 204. Each offer can include, for example, an identification of an item of content that the associated content provider wishes to present in the content module 204. Additionally or alternatively, the offer can identify an item (e.g., a payment, a good, a service, etc.) that the content provider is willing to provide to the content manager 106 (or operator thereof) in exchange for presenting the content provider's item of content.

After receiving the offers from the content providers 212, the content manager 106 can select (step 216) one of the offers. The selection can be made based on a variety of factors, including, for example, a compatibility between the offered item of content and the criteria for the content module 204, technical requirements of client devices associated with the content module, the type of content, the length of content, the offered item, and/or other factors. The content manager 106 can then identify (step 218) the item of content associated with the selected offer and send (step 220) the identification to the content server 108. The content server 108 can retrieve (step 222) the item of content (e.g., from the content data 120 database) and/or generate a link to the item of content. The content server 108 can then send (step 224) the item of content or the link to the content module 204, which can present (step 226) the item of content on one or more client devices 228 (e.g., client device 126, 128, 130, 132, and/or 134).

In various examples, steps 214-226 can be repeated multiple times as new offers to present content are received from the content providers 212 and selected by the content manager 106. In this way, the content presented on the client devices 228 can come from a wide variety of content providers. For example, when an offer from content provider A is accepted, the content module 204 can be used to present content from content provider A. When an offer from content provider B is later accepted (e.g., due to a better or more compatible offer from content provider B), the content module 204 can be used to present content from content provider B. In this case, the content module 204 can switch from presenting content from content provider A to content from content provider B. Such changes can occur repeatedly, preferably in real-time, as new offers are received and selected by the content manager 106.

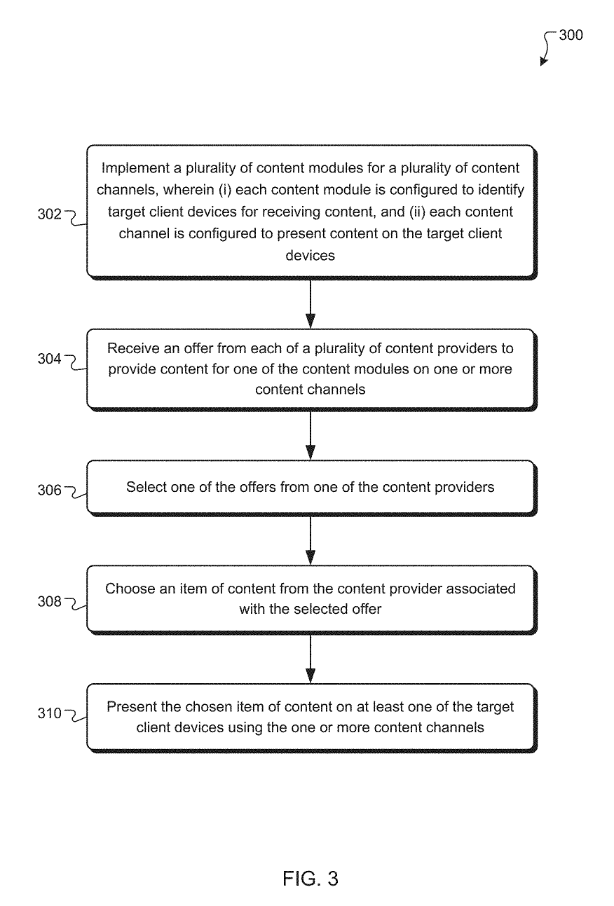

FIG. 3 illustrates an example computer-implemented method 300 of managing the presentation of content on client devices. A plurality of content modules are implemented (step 302) for a plurality of content channels. Each content module is configured to identify target client devices for receiving content. Each content channel is configured to deliver content to the target client devices. An offer is received (step 304) from each of a plurality of content providers to provide content for one of the content modules on one or more content channels. One of the offers from one of the content providers is selected (step 306). An item of content is chosen (step 308) from the content provider associated with the selected offer. The chosen item of content is presented (step 310) on at least one of the target client devices using the one or more content channels.

In various examples, the content manager 106 can integrate with multiple content channels and can make multi-channel content available through a centralized application programming interface (API). The content manager 106 can integrate with individual content channels to acquire content. The content manager 106 can launch and manage content modules for content providers via a content channel's API. In some instances, the content manager 106 can operate a single API that can be used to programmatically obtain access to content across multiple content channels. As part of this API, the content manager 106 can receive and accept offers to achieve real-time content targeting. Some content channels may not offer an API for processing offers from the content manager 106 to acquire content. In such a scenario, the content manager 106 can send periodic offers (e.g., each day, week, or other appropriate time period) as defined by an offer file (e.g., a CSV file or the like). The offers can be processed (e.g., manually or automatically) by the content channel.

While certain large-scale content channels (e.g., large websites or popular web services, such as GOOGLE or FACEBOOK) can offer API access to module creation and management features, smaller content channels may not offer such API access and/or may not allow the content manager 106 to use its own servers or click redirects to manage content modules. In such instances, the content manager 106 can programmatically launch a set of content modules for each content provider in communication with the content manager 106. The content modules in this case can be specific to a content provider, rather than being available to multiple content providers, using the real-time offer mechanism described herein.

In some examples, each content channel can have a content inventory that represents available space or instances where content can be provided. The content manager 106 can have or obtain access to the content inventory through interactions with the content channels. In some instances, an entity controlling the content manager 106 can obtain such access for the content manager 106. Advantageously, by receiving and accepting offers from the content providers, the content manager 106 is able to provide the content providers with access to the content inventory.

In certain implementations, an entity that controls the content manager 106 can purchase the content inventory from a conglomerate of content channels. The entity can achieve business integration with the content channels (or the entities operating the content channels), which can involve or include, for example, API integration, contract formation, etc. For each content channel, the content manager 106 (e.g., as operated by the controlling entity) can create and manage multiple content modules with granular targeting (e.g., according to client device type, operating system, geographical location, etc.). Alternatively or additionally, the content manager 106 can deploy a set of streamable content, which can be streamed from the content server 108. This can allow content within a content channel or content module to be changed and managed in real-time. For example, as content providers provide additional offers, the content manager 106 can choose offers from different content providers, such that content from multiple content providers can be presented and changed (in real-time) within a content module. The desired content can be retrieved from the content server 108 and/or the content server 108 can provide the content to the content channels.

In various implementations, the content can be provided with a click destination universal resource locator (URL) that allows users to select the content and be directed to a website or mobile application (e.g., for an online store or a mobile app store). The content manager 106 is preferably able to embed the click destination URL into the content and adjust the URL accordingly, in real-time, as the content is changed or updated. Alternatively or additionally, the click destination URL embedded in the content can remain directed to a first website that can redirect users to other websites, as appropriate, once the users arrive at the first website. For example, if the content provider wishes to direct a user to website A when the user clicks on a click destination URL, the user can be either (i) sent directly to website A or (ii) sent initially to the first website, which can then redirect the user to website A. In some instances, the content manager 106 can pass the click destination URL as a metavariable to the content channel, which can embed the URL in content and/or otherwise direct users to the URL when the content is selected. Alternatively or additionally, the content manager 106 can host a portion or all of a website landing page (or software application) for a content provider, such that click-redirects can be handled and managed by the content manager 106, rather than by a content channel or other external website or server. The content manager 106 can, in some cases, host or share a lookup table or other suitable mechanism that can map an item of content to a desired click destination URL. In some examples, content providers can track click-redirects and/or otherwise monitor steps taken by users after an embedded URL is selected. This can allow the content providers to determine how the content may have influenced the user to take certain actions (e.g., visit websites and/or complete certain transactions on websites).

To choose an offer from the content providers, the content manager 106 can establish an offer processing system. The content manager 106 can employ any suitable set of offer processing rules, including, but not limited to, open or sealed offer processing, first price or second price offer processing, combinatorial offer processing, or any other suitable offer processing rules.

The content inventory can be, for example, arranged as quantum inventory (e.g., individual items of content) or bundled inventory. For bundled inventory, the content manager 106 can use any appropriate form of clustering to group or package features into bundles. For example, instead of providing individual mobile content placements, the content manager 106 can use machine learning or other suitable algorithms or techniques to create content clusters, and offer placement within individual or multiple clusters through its offer processing system. This can allow content providers to access massive multi-channel inventory through a single marketplace offered by the content manager 106.

Once offer rules have been established, the content manager 106 can solve a corresponding winner determination problem (WDP), and can assign each content provider to a winning inventory according to the rules. A solution to the WDP can involve, for example, determining a selection of content that provides a best match with module criteria (e.g., device type or settings) and/or that achieves a desired revenue for a content channel.

In various implementations, content providers can submit offers to the content manager 106 at any time. For example, the content manager 106 can establish an API that allows content providers to submit offers to the content manager 106. The content manager 106 can then select an offer and embed a click destination URL into the content, as described herein. For content inventory that is acquired by and/or assigned to a given content provider, the content manager 106 can then configure the content server 108 to present the content provider's content and update any associated click destination URLs.

In certain examples, the content manager 106 can launch and manage a large set of individual content modules (as well as sub-modules) with broad spectrum targeting or criteria for choosing client devices that receive content. Such targeting may include all combinations or any subset of combinations of the available targeting criteria. For example, a unique content module can be created for each combination of geographical location, platform (e.g., ANDROID), device type, device/user language, operating system, and sub-modules, with additional targeting criteria such as placement (e.g., publisher, search keyword, video, etc.), time of day, day of week, etc. Alternatively or additionally, the content manager 106 can leverage machine learning or other suitable algorithms or techniques to create clusters (e.g., of multiple content modules) for any of the available targeting options. For example, instead of using each available geographical location (e.g., country) as a factor in the combinatorial module generation outlined above, the content manager 106 can use geographical tiers or clusters, based on economic, geographic, cultural indicators, etc. As another example, instead of creating sub-modules for each of possibly hundreds of thousands of possible placements, the content manager 106 can create placement clusters based on such factors as, for example, placement user demographics, category, business vertical, or any publically or privately available data on placements. The goals of such clustering techniques can be to (A) make the combinatorial module generation more tractable and/or (B) make the performance metrics for the resulting content segments measurable in a meaningful way.

As described herein, the content manager 106 can use or access the content server 108 to obtain and present content in real-time on multiple channels. In some instances, a content channel can ping the content server 108 with information about a client device (e.g., geographical location, platform, device type, operating system, etc.). The content server 108 can then select an item of content, for example, based on a winner of a corresponding offer processing system hosted by the content manager 106. The content server 108 can then send the item of content along with a corresponding click destination URL to the content channel. In other words, specific items of content can be selected for a client device according to one or more criteria associated with the client device. Alternatively or additionally, content for the content providers can be hosted by each individual content channel, for example, with a corresponding content identifier (ID). The content manager 106 can then host a server (e.g., the content server 108), which can have a lookup table or other suitable mechanism for mapping module or sub-module IDs to corresponding content IDs or, preferably without loss of generality, to corresponding client IDs. Whichever method is used, the content manager 106 can select an offer from the content providers (e.g., based on module criteria) and update the content for a module based on the selected offer. In some examples, the offer is selected by identifying a best match between the offered content and the device, for example, according to technical requirements (e.g., device type, connection type, operating system, etc.) Alternatively or additionally, the offer can be selected by holding a real-time offer processing system.

Various offer processing rules can be used by the content manager 106 to select an offer from content providers. In some instances, for example, the content manager 106 can acquire content inventory from content channels at a given offer value (e.g., determined by the content manager 106) and can then resell the inventory through offer processing using second-price rules (e.g., Vickrey-Clarke-Grove mechanism or the like). Alternatively or additionally, the content manager 106 can resolve offer processing and determine pricing based on second-price rules and pay content channels a corresponding third price, therefore benefiting from arbitrage.

In some instances, the offer processing system can be implemented using any suitable offer processing mechanism, including, for example, quantum or bundled. A quantum offer processing system can be a real-time offer processing system that allows content providers to submit offers for presenting content on individual client devices (e.g., offer processing can be performed for each item of content served to each unique client device in real-time). Content providers can submit offers based on individual users or client devices with associated meta-data (e.g., geographical location, platform, device type, operating system, placement, etc.). The offer processing can be resolved within milliseconds and the associated item of content can be served (e.g., using the content server 108) to the client device.

On the other hand, a bundled offer processing system generally allows content providers to submit offers for bulk content packages, with any level of granular targeting. For example, in the technical integration of the content manager 106 with a given content channel, the content manager 106 can deploy a large set of combinatorial offer processing systems based on device features available through the content channel, or based on derived features such as geography or placement clusters determined by the content manager 106. The content manager 106 can then perform offer processing in which content providers can submit offers on individual bundles, as opposed to individual unique users or client devices. The bundles can be arbitrarily granular so as to represent a unique combination of features.

An exemplary implementation of a bundled offer processing system can achieve real-time, asynchronous bundled offer processing. For example, the content manager 106, via its API, can offer bundled content segments based on a specification of any combination of content features. Content providers can submit granular offers (e.g., a unique offer for each combination of features supported by the content provider 106), or broad offers (e.g., specifying values or a range of values for a subset of features). The content providers in the bundled offer processing system may then submit an offer at any time to the content provider. There are preferably no quantum offer requests that need to be resolved. Instead, the content providers can submit offers based on permissible device or user features determined by the content manager 106.

In some instances, an offer can be or include, for example, an offer value, a selection of targeting features for which the offer applies, and/or a budget. For the offer value, the content manager 106 can determine a suitable basis, such as cost per impression (CPM), cost per click (CPC), cost per action (CPA), or cost per unit (CPU). A CPU offer can have a unique meaning as specified by the content manager 106. For example, the content manager 106 can make content available for a given content module over a specified duration of time, so that, for example, client devices associated with the content module can receive or present an item of content for a single second of time. Alternatively or additionally, the content manager 106 can make content available based on CPM or CPC, etc.

The selection of targeting features can include, for example, a specification of a desired targeting (e.g., client device features) for the content provider. This can include, in some instances, all targeting features (granular) or a subset of targeting features (broad). For purposes of illustration and not limitation, an example of broad targeting can be all client devices in a specific country (e.g., Germany) that use the ANDROID platform (e.g., without regard for OS version, particular device, time of day, carrier, and/or similar device or user criteria).

A final component of the offer can be the budget, which can specify a maximum amount the content provider is willing to buy of the given targeting (e.g., at a given price point). The budget can be either a budget for a particular offer or a budget that can be shared across multiple offers. For example, the content provider may want to specify a unique budget for each possible combination of content, or may want to specify a smaller set of budgets or even one overall budget. A budget ID can correspond to a single budget that is shared across multiple offers.

In the context of bundled offer processing systems, asynchronous can mean that content providers are not required to submit offers in the offer processing system at the same time. Thus, content providers can enter the offer processing systems at any time by submitting an offer (e.g., including a set of criteria for targeting client devices). The submitted offer can then be resolved within an existing matrix. In particular, a new offer from a new content provider can displace an old content provider, in which case the new content provider can win at a second price of the old content provider (e.g., based on second-price offer processing rules) for a remainder of the new content provider's budget. Alternatively or additionally, the new content provider may not win but may act as or provide a new second price to the old content provider. In such a case, the old content provider can now pay a higher second price for a remainder of the old content provider's budget. When the old content provider's budget is met, or when the old content provider exits the offer processing system, the new content provider can win the offer processing system and pay a next highest price.

Advantageously, the systems and methods described herein are able to achieve a new type of real-time offer processing system. Some such systems, for example, can be conducted at an individual content item level and/or can require an actual user to exist and/or a single spot to be available for serving content. Offer processing can be conducted within the blink of an eye in order to determine which content provider can present content to a specific user. This approach can achieve quantum offer processing in which participants can submit offers at the quantum level (i.e., unique offers for each unique item of content for a single user). By contrast, in the bundled offer processing system described herein, content providers are generally not required to wait for nor respond to individual offer requests. The bundled offer processing system can be conducted at real-time, however, as content providers can submit offers for any combination of targeting at any time. The offer processing resolution can be updated on-the-fly to account for new offers, when received. In various examples, the content described herein can be or include, for example, a movie, a television show, a documentary, a newspaper or magazine article, a podcast, a song, and/or an advertisement (e.g., a mobile advertisement).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A computer-implemented method, comprising:
implementing a plurality of content modules for a plurality of content channels,
wherein each content module is configured to identify target client devices for receiving content, and
wherein each content channel is configured to present content on the target client devices;
receiving an offer from each of a plurality of content providers to provide content for one of the content modules on one or more content channels;
selecting one of the offers from one of the content providers;
choosing an item of content from the content provider associated with the selected offer; and
presenting the chosen item of content on at least one of the target client devices using the one or more content channels.

2. The method of claim 1, wherein each content module is configured to identify the target client devices based on one or more client device features.

3. The method of claim 2, wherein the one or more client device features comprise at least one of device type, device location, operating system, and platform.

4. The method of claim 1, wherein the one or more content channels comprise at least one of a website and a software application.

5. The method of claim 1, wherein the chosen item of content comprises at least one of an image and a video.

6. The method of claim 5, wherein the chosen item of content further comprises a click destination universal resource locator.

7. The method of claim 1, wherein presenting the chosen item of content comprises:
providing the chosen item of content from a content server to the one or more content channels.

8. The method of claim 1, wherein presenting the chosen item of content comprises:
submitting a second offer to provide the chosen item of content on the one or more content channels; and
receiving an acceptance of the second offer.

9. The method of claim 1, further comprising:
receiving a third offer from each of the plurality of content providers to provide content for the one of the content modules on the one or more content channels;
selecting one of the third offers from a different one of the content providers;
choosing a new item of content from the content provider associated with the selected third offer; and
presenting the new item of content on at least one of the target client devices using the one or more content channels.

10. The method of claim 1, wherein the content comprises a bundling of bulk content inventory.

11. A system, comprising:
one or more computer processors programmed to perform operations comprising:
implementing a plurality of content modules for a plurality of content channels,
wherein each content module is configured to identify target client devices for receiving content, and
wherein each content channel is configured to present content on the target client devices;
receiving an offer from each of a plurality of content providers to provide content for one of the content modules on one or more content channels;
selecting one of the offers from one of the content providers;
choosing an item of content from the content provider associated with the selected offer; and
presenting the chosen item of content on at least one of the target client devices using the one or more content channels.

12. The system of claim 11, wherein each content module is configured to identify the target client devices based on one or more client device features.

13. The system of claim 12, wherein the one or more client device features comprise at least one of device type, device location, operating system, and platform.

14. The system of claim 11, wherein the one or more content channels comprise at least one of a website and a software application.

15. The system of claim 11, wherein the chosen item of content comprises at least one of an image and a video.

16. The system of claim 11, wherein presenting the chosen item of content comprises:
providing the chosen item of content from a content server to the one or more content channels.

17. The system of claim 11, wherein presenting the chosen item of content comprises:
submitting a second offer to provide the chosen item of content on the one or more content channels; and
receiving an acceptance of the second offer.

18. The system of claim 11, the operations further comprising:
receiving a third offer from each of the plurality of content providers to provide content for the one of the content modules on the one or more content channels;
selecting one of the third offers from a different one of the content providers;
choosing a new item of content from the content provider associated with the selected third offer; and
presenting the new item of content on at least one of the target client devices using the one or more content channels.

19. The system of claim 11, wherein the content comprises a bundling of bulk content inventory.

20. An article, comprising:
a non-transitory computer-readable medium having instructions stored thereon that, when executed by one or more computer processors, cause the computer processors to perform operations comprising:
implementing a plurality of content modules for a plurality of content channels,
wherein each content module is configured to identify target client devices for receiving content, and
wherein each content channel is configured to present content on the target client devices;
receiving an offer from each of a plurality of content providers to provide content for one of the content modules on one or more content channels;
selecting one of the offers from one of the content providers;
choosing an item of content from the content provider associated with the selected offer; and
presenting the chosen item of content on at least one of the target client devices using the one or more content channels.
